(19) United States
(12) Patent Application Publication
(10) Pub. No.: US 2026/0350756 A1
(43) Pub. Date: Nov. 5, 2026

(54) EFFICIENT VIDEO GENERATION WITH PRETRAINED MASK TO IMAGE MODELS AND SPARSELY DISTRIBUTED MASKS

(71) Applicant: GE Precision Healthcare LLC, Waukesha, WI (US)

(72) Inventors: Elay Dahan, Ramat Gan (IL); Nati Daniel, Haifa (IL); Hedda Cohen Indelman, Haifa (IL); Doron Shaked, Kiryat Tiv'on (IL); Orit Dudek, Haifa (IL); Amitay Lev, Or Akiva (IL)

(21) Appl. No.: 19/197,694

(22) Filed: May 2, 2025

(51) Int. Cl. G06T 5/70; G06T 5/60

(52) U.S. Cl. CPC G06T 5/70; G06T 5/60; G06T 2207/10016

(57) ABSTRACT

One or more systems, devices, computer program products and/or computer-implemented methods of use provided herein relate to developing continuous videos from sampled masks. Accordingly, a system can comprise a memory that can store computer executable components. The system can further comprise a processor that can execute at least one of the computer executable components. The computer executable components can comprise an access component that accesses a set of masks and a corresponding context; an image generation component that utilizes a pretrained mask-to-image model to generate a sequence of images based on the set of masks and corresponding context; a prediction component that predicts what a missing frame should look like, based on the generated sequence of images, and utilizes the pretrained mask-to-image model to generate the missing frame; and a synthesis component that integrates the generated missing frame into the sequence of images to create a smooth video.

### TECHNICAL FIELD

The subject disclosure relates generally to generating videos from images, and more specifically to transforming mask-to-image models into video generation models.

### BACKGROUND

Video generation is a computationally intensive task that involves synthesizing temporally coherent image sequences. Traditional video generation models are often extensions of noise-to-image or conditional image generation models, wherein individual frames are generated sequentially or conditioned on prior frames. However, state-of-the-art (SOTA) video generation models employ a different approach by generating spatially and temporally correlated frames in a single inference step. This methodology ensures consistency in motion and structure across frames but presents substantial computational challenges due to the increased dimensionality of video data compared to static images.

Despite advancements in video generation, existing models face inherent limitations, particularly concerning video length and resolution. Given the high-dimensional nature of video data, current models require significant computational resources, particularly in terms of GPU memory. As a result, the length of the generated videos is typically constrained and remains fixed, reducing the adaptability of such models for applications requiring variable-length outputs. These constraints pose significant challenges for scalability and broader applicability across various domains.

A predominant approach in video generation involves text-to-video synthesis, wherein a neural network generates video sequences based on natural language descriptions. While this approach has demonstrated efficacy for natural image datasets, its applicability in specialized fields, such as medical imaging, is considerably restricted. Unlike conventional datasets used for text-to-video training, medical imaging datasets rarely contain detailed textual descriptions associated with images or videos. The scarcity of structured text-to-video data in the medical domain presents a substantial obstacle to the development of effective video generation models tailored to this field.

Within medical imaging, video generation techniques hold particular relevance for applications such as synthesizing imaging sequences, simulating disease progression, and enhancing diagnostic training tools. However, existing models rely heavily on text-conditioned training methodologies, which are largely impractical for medical imaging due to the absence of corresponding textual descriptions. Unlike natural image datasets, which frequently include descriptive annotations, medical imaging datasets primarily consist of numerical, categorical, or metadata-based information. This fundamental difference necessitates the development of alternative video generation techniques that do not depend on extensive textual conditioning.

Overcoming these challenges requires novel approaches that optimize video generation for high-dimensional data while addressing GPU memory limitations. Furthermore, there is a critical need for methodologies tailored to specialized domains such as medical imaging, where text-conditioned synthesis is not a viable option. The development of techniques capable of generating variable-length videos without excessive computational overhead while maintaining high fidelity and temporal consistency would significantly enhance the utility of video generation models across diverse applications. Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate developing continuous videos from sparsely sampled masks are provided.

According to one or more embodiments, a system is provided. The system can comprise a non-transitory computer-readable memory that can store computer-executable components. The system can further comprise a processor that executes at least one of the computer executable components that can access a set of masks and a corresponding context. In various aspects, the at least one of the computer executable components can further generate a sequence of images based on the set of masks and corresponding context. In various instances, the at least one of the computer executable components can further predict what a missing frame should look like, based on the generated sequence of images, and generates the missing frame. In various aspects, the at least one of the computer executable components can further integrate the generated missing frame into the sequence of images to create a smooth video.

According to one or more embodiments, a computer-implemented method is provided. In various embodiments, the computer-implemented method can comprise accessing, by a system operatively coupled to a processor, a set of masks and a corresponding context. In various aspects, the computer-implemented method can comprise generating, by the processor, a sequence of images based on the set of masks and corresponding context. In various aspects, the computer-implemented method can comprise predicting, by the processor, what a missing frame in the sequence of images should look like, based on the generated sequence of images. In various instances, the computer-implemented method can comprise generating, by the processor, the missing frame. In various instances, the computer-implemented method can comprise integrating, by the processor, the generated missing frame into the sequence of images to create a smooth video.

According to one or more embodiments, a computer program product for facilitating developing continuous videos from sparsely sampled masks is provided. In various embodiments, the computer program product can comprise a non-transitory computer-readable memory having program instructions embodied therewith. In various aspects, the program instructions can be executable by a processor to cause the processor to access a set of masks and a corresponding context. In various cases, the program instructions can be further executable to cause the processor to generate a sequence of images based on the set of masks and corresponding context. In various aspects, the program instructions can be further executable to cause the processor to predict what a missing frame in the sequence of images should look like, based on the generated sequence of images. In various cases, the program instructions can be further executable to cause the processor to generate the missing frame. In various aspects, the program instructions can be further executable to cause the processor to integrate the generated missing frame into the sequence of images to create a smooth video.

### DESCRIPTION OF THE DRAWINGS

FIG. 1 illustrates a block diagram of an example, non-limiting system that facilitates developing continuous videos from sparsely sampled masks in accordance with one or more embodiments described herein.

FIG. 2 illustrates a block diagram of an example, non-limiting system that facilitates developing continuous videos from sparsely sampled masks in accordance with one or more embodiments described herein.

FIG. 3 illustrates a flow diagram of an example, non-limiting computer-implemented method that facilitates developing continuous videos from sparsely sampled masks in accordance with one or more embodiments described herein.

FIG. 4 illustrates a flow diagram of an example, non-limiting computer-implemented method that facilitates developing continuous videos from sparsely sampled masks in accordance with one or more embodiments described herein.

FIG. 5 illustrates an example, non-limiting system architecture 500 that can facilitate developing continuous videos from sparsely sampled masks in accordance with one or more embodiments described herein.

FIG. 6 illustrates an example, non-limiting system architecture 600 of a mask-to image-model that can facilitate developing continuous videos from sparsely sampled masks in accordance with one or more embodiments described herein.

FIG. 7 illustrates an example, non-limiting system architecture 700 of an image-generation model that can facilitate developing continuous videos from sparsely sampled masks in accordance with one or more embodiments described herein.

FIG. 8 illustrates a block diagram of an example, non-limiting operating environment in which one or more embodiments described herein can be facilitated.

FIG. 9 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Video generation is a computationally demanding task requiring the synthesis of temporally coherent image sequences. Conventional video generation models often extend existing noise-to-image or conditional image generation frameworks, where frames are either generated sequentially or conditioned on prior frames. State-of-the-art (SOTA) models in video generation employ an alternative approach, producing spatially and temporally correlated frames within a single inference step. While this methodology ensures motion consistency and structural coherence, it presents considerable computational challenges due to the high dimensionality of video data. Moreover, the generation process remains constrained by hardware limitations, particularly GPU memory, which restricts the length and resolution of generated videos.

Existing approaches predominantly rely on text-to-video synthesis, wherein a neural network generates a video sequence based on textual descriptions. Although this technique has proven effective in domains with abundant text-annotated datasets, its applicability to specialized fields such as medical imaging is considerably limited. In medical imaging, text-to-video training pairs are exceedingly rare, as image and video datasets primarily consist of segmentation masks and metadata rather than descriptive text. This limitation renders conventional text-conditioned video generation methods impractical for medical applications, necessitating alternative approaches tailored to this domain.

Accordingly, systems or techniques that can address one or more of these technical problems can be desirable.

Various embodiments described herein can address one or more of these technical problems. Systems, computer-implemented methods, apparatus, or computer program products described herein can facilitate transforming existing mask-to-image models into video generation models. In particular, such a system can accept a sparse or dense set of segmentation masks as input and can output a continuous video sequence. A pretrained mask-to-image (M2I) model can be utilized to generate images corresponding to the input masks. However, since the input masks do not inherently form a temporally smooth sequence, a frame generation model can be subsequently applied to predict intermediate frames. This in-between frame prediction can ensure spatial-temporal continuity, producing a visually coherent video output from the sparse input masks. Notably, the systems described herein can be model-agnostic and can incorporate any existing mask-to-image model. In particular, the Context-Semantic Diffusion Model can be employed, which can generate images that align with the input masks in terms of geometry while adhering to the context for texture representation.

A frame generation model can further enhance the described system's capability by synthesizing intermediate frames between sparsely generated images. This model can accept two reference frames as input and predict one or more in-between frames, ensuring smooth temporal transitions. Unlike conventional next-frame prediction models, which rely on a dense sequence of video frames for training, the proposed frame generation approach does not require a fully annotated video dataset. Instead, it can leverage sparsely distributed input masks and corresponding images, making it particularly suited for medical imaging applications where acquiring densely annotated video data is impractical.

Unlike existing auto-regressive video generation models that necessitate extensive video training datasets, the proposed system can operate using only mask and image data, eliminating dependency on video-based training. Additionally, unlike conventional motion estimation methods, which rely on dense image sequences for motion prediction, the present invention can generate a smooth video from a sparse set of input masks. Further, the present invention diverges from prior methods that reconstruct video sequences through deterministic mappings of medical images, as it can employ generative modeling techniques to synthesize new frames that were not originally present in the input dataset. By combining mask-to-image transformation with frame generation, this approach can overcome the limitations of conventional video generation techniques and enable efficient, high-quality video synthesis for specialized applications such as medical imaging.

One or more embodiments described herein can include systems, computer-implemented methods, apparatus, or computer program products that can facilitate developing continuous videos from sparsely sampled masks. In particular, the inventors of various embodiments described herein realized that existing video generation approaches are constrained by the need for densely annotated video datasets, limiting their applicability in domains such as medical imaging, where only sparse segmentation masks are typically available. The inventors of the present invention further realized that, by leveraging pretrained mask-to-image models in conjunction with a frame generation model, it is possible to synthesize temporally coherent video sequences without requiring a fully annotated video dataset. The novel approach developed by the inventors enables the generation of continuous videos from sparsely sampled masks while maintaining spatial and temporal consistency, thereby overcoming the limitations of conventional video generation techniques.

Accordingly, various embodiments described herein can be considered as improving video generation technology by eliminating the dependency on densely annotated video datasets and enabling the synthesis of temporally coherent video sequences from sparse segmentation masks. Traditional video generation techniques rely on extensive training datasets containing fully annotated video sequences, which are often impractical or unavailable in specialized domains such as medical imaging. By contrast, the proposed system can utilize a pretrained mask-to-image model to generate high-quality images from sparse segmentation masks and can apply a frame generation model to synthesize intermediate frames, ensuring smooth and realistic temporal transitions. Accordingly, various embodiments described herein can be considered as improving video generation technology by enhancing the efficiency of video generation and expanding its applicability to fields where acquiring densely annotated video data is infeasible. Unlike conventional next-frame prediction methods that require a dense sequence of preceding frames, the present approach interpolates missing frames, allowing for the creation of temporally coherent videos even when only a subset of key frames is available. This can significantly reduce data requirements and computational overhead typically associated with video generation models. The embodiments described herein can provide a scalable and adaptable solution for generating high-quality videos across various applications.

Various embodiments described herein can be considered as a computerized tool (e.g., any suitable combination of computer-executable hardware or computer-executable software) that can facilitate developing continuous videos from sparsely sampled masks. In various aspects, such computerized tools can comprise an access component, an image generation component, a prediction component, a synthesis component, an identification component, or an artificial intelligence (AI) component.

In various embodiments, the access component can retrieve a set of masks and a corresponding context from a data source, which can include databases, local storage, cloud-based repositories, or real-time input streams. The set of masks accessed by the access component can be a sparse or dense set of segmentation masks, where each mask can represent a structured abstraction of a corresponding image. In the context of medical imaging, segmentation masks can be used to delineate anatomical structures, pathological regions, or other relevant features within an image. Unlike conventional video datasets that require densely annotated frames, the accessed masks can be limited in number and irregularly distributed over time, requiring additional processing to generate a smooth video sequence. The access component can retrieve these masks in various formats, including binary masks, multi-class segmentation maps, or probabilistic masks, depending on the dataset and the intended application. The access component can access a corresponding context, which can provide additional information necessary for image generation. The set of masks and corresponding context can pertain to medical imaging. The context can include metadata associated with masks, such as imaging modality (e.g., MRI, CT, ultrasound), acquisition parameters, or patient-specific information relevant to generation of realistic images. Where the masks represent segmented anatomical structures, lesions, or regions of interest, the corresponding context can provide relevant texture and appearance information derived from medical imaging modalities. The context can encompass reference images, feature embeddings, or prior model-generated outputs that can help guide image generation. In an embodiment utilizing a Context-Semantic Diffusion Model, the context can provide a texture or appearance reference, ensuring that the generated images align with the geometric structure defined by the masks and with expected visual characteristics of the target domain. The access component can implement various preprocessing techniques to optimize the retrieved masks and context before passing them to subsequent components. The access component can normalize mask dimensions, standardize intensity values, or apply geometric transformations to ensure consistency across a dataset. Where masks are derived from heterogeneous sources, the access component can resolve inconsistencies by harmonizing mask formats, interpolating missing data, or performing spatial alignment to enhance compatibility.

In various embodiments, the image generation component can utilize a pretrained mask-to-image model to generate a sequence of images based on the set of masks and corresponding context. The sequence of images generated by the image generation component can align with the geometric structure defined by the masks while adhering to the visual characteristics provided by the context. The image generation component can be designed to process both sparse and dense sets of masks, ensuring that each generated image maintains consistency in spatial structure and appearance. When the access component retrieves a sparse set of masks, the image generation component can generate images corresponding to the available masks while preserving contextual and textural continuity across frames. The image generation component can employ a diffusion-based technique to iteratively refine the generated images, ensuring that each image adheres to the geometry of the input masks while maintaining visually realistic textures from the corresponding context. This iterative refinement can involve progressive noise removal and feature enhancement, allowing the model to generate high-fidelity images that accurately reflect the underlying structures represented by the masks. Additionally, the image generation component can utilize a pretrained mask-to-image model, such as the Context-Semantic Diffusion Model, which can incorporate learned representations of domain-specific textures and structures to improve the realism of the generated images. The image generation component can also incorporate adaptive techniques to balance geometric fidelity with texture realism. For example, the image generation component can apply context-aware weighting mechanisms to ensure that fine-grained details from the context are preserved while strictly adhering to the mask constraints. Furthermore, the image generation component can support multi-resolution processing, allowing images to be generated at different scales to accommodate various downstream applications.

In various embodiments, the prediction component can predict what a missing frame should look like based on the generated sequence of images. The prediction component can analyze the spatial and temporal relationships between existing frames to generate intermediate frames that ensure smooth visual transitions. When the access component retrieves a sparse set of masks and the image generation component generates images for the available masks, the prediction component can generate the missing frames to maintain temporal consistency across the video sequence. The prediction component can utilize a pretrained mask-to-image model to generate the missing frames. This predictive capability can be particularly beneficial in scenarios where the original input data lacks a complete sequence of frames, as it allows for the reconstruction of a continuous video from limited initial inputs. The prediction component (e.g., utilizing a pretrained mask-to-image model) can generate missing frames using a frame generation process based on in-between frame prediction. This approach can estimate and synthesize the appearance of intermediate frames by analyzing the structure and content of adjacent frames. Given two reference frames xᵢ and xⱼ, the missing frame \hat{x}ₜ can be predicted (e.g., by the prediction component) using the function f(xᵢ,xⱼ)=\hat{x}ₜ, where t∈(i, j). This function can incorporate motion estimation techniques, optical flow analysis, or deep-learning-based interpolation methods to predict intermediate frames with high accuracy. By leveraging these techniques, the prediction component can generate temporally consistent frames that align seamlessly with the surrounding images, ensuring that the resulting video maintains both structural integrity and smooth transitions. Generating the missing frames using the frame generation process can enable smooth interpolation without requiring training on data from a specific target modality. Unlike conventional next-frame prediction models that rely on dense training datasets from a specific domain, the in-between frame prediction process can operate across various modalities and applications. The prediction component can adaptively estimate motion and texture details based on the available frames, making it highly flexible for different types of video generation tasks, including medical imaging, scientific visualization, and general-purpose video synthesis.

In various embodiments, the synthesis component can integrate the generated missing frame into the sequence of images to create a smooth video. The synthesis component can take the predicted intermediate frames produced by the prediction component and seamlessly position them between the corresponding reference frames to ensure that transitions appear natural and fluid. By aligning the missing frames with the surrounding images, the synthesis component can mitigate visual artifacts, abrupt transitions, or inconsistencies that may arise when interpolating between sparsely sampled input data. This integration process can enhance the realism of the generated video, making it suitable for applications that require high temporal and spatial fidelity. The synthesis component can employ various techniques to refine the integration process, including blending algorithms, temporal filtering, and motion smoothing. These techniques can help minimize discrepancies between adjacent frames, ensuring that the transitions between generated and original frames are indistinguishable. Additionally, the synthesis component can perform adaptive adjustments to harmonize brightness, contrast, and texture details across frames, preventing visible discontinuities. In some implementations, it can leverage deep-learning-based refinement models to further enhance frame alignment and smoothness, optimizing the overall perceptual quality of the generated video. By integrating missing frames in a structured manner, the synthesis component can construct a continuous video sequence even when the input data consists of only a sparse set of segmentation masks. This capability can be particularly beneficial in domains such as medical imaging, where obtaining fully annotated video data is challenging. The synthesis component can ensure that the final video output accurately represents the intended motion and structure, preserving both the geometric constraints of the input masks and the contextual details provided by the image generation component.

In various embodiments, the system can include an adaptive temporal resolution component that can dynamically adjust the number of generated frames based on the complexity of motion in the scene. For example, in areas where motion is minimal, the system can reduce the number of interpolated frames, while in regions with high motion dynamics, additional intermediate frames can be synthesized to enhance smoothness. The system can analyze spatial-temporal gradients within the image sequence to determine the optimal number of interpolated frames, ensuring that the synthesized video maintains a natural motion flow without unnecessary computational overhead.

In another embodiment, the system can include an uncertainty estimation component that can evaluate the confidence level of the generated images and missing frames. The uncertainty estimation component can assess prediction uncertainty using probabilistic modeling techniques, such as Bayesian networks or Monte Carlo dropout, and assign confidence scores to each generated frame. If uncertainty surpasses a predefined threshold, the system can refine the generated frame using additional context or enhance it with adversarial training techniques.

In some embodiments, the system can employ a multi-scale processing framework that generates video sequences at different resolutions to enhance flexibility across various applications. A hierarchical approach can be utilized, wherein the system first generates a low-resolution video sequence to establish the overall motion dynamics before refining details at higher resolutions. This technique can improve the computational efficiency of the model by allowing coarse-to-fine synthesis, where lower-resolution frames guide the generation of higher-resolution outputs.

In various embodiments, the system can further comprise a feedback optimization component that can iteratively refine the generated video sequence based on quality assessments. The feedback optimization component can compare the synthesized video against learned representations of real-world sequences, using perceptual loss functions, structural similarity indices, or adversarial training feedback to identify inconsistencies. Based on these assessments, the system can iteratively adjust mask-to-image translations, in-between frame predictions, or synthesis techniques to improve output quality.

In another embodiment, the system can further comprise a domain adaptation component that can fine-tune the mask-to-image and frame prediction models for different modalities or datasets. The domain adaptation component can utilize transfer learning techniques to adapt pretrained models to new environments with minimal labeled data. For instance, if the system is initially trained on general medical imaging datasets but later needs to generate videos for a specialized imaging modality, the domain adaptation component can adjust model parameters to optimize performance for the new domain.

In certain embodiments, the system can incorporate real-time processing capabilities to generate and refine video sequences on demand. By optimizing computational efficiency through model quantization, hardware acceleration (e.g., GPU/TPU inference), and parallelized processing pipelines, the system can enable near-instantaneous video generation for interactive applications.

In various embodiments, the identification component can examine the generated sequence of images and identify a missing frame within the sequence of images. The identification component can analyze the temporal consistency and spatial alignment of the generated frames to detect gaps, irregular transitions, or missing data points within the sequence. The identification component can operate by scanning the input sequence and applying various image-processing and machine-learning techniques to determine whether any frames are absent or if additional interpolated frames are required to maintain a smooth and coherent video. The identification component can employ multiple detection strategies to assess the completeness of the generated video sequence. In one embodiment, it can utilize a frame-indexing approach, where it sequentially checks for expected frame positions based on the initial mask input distribution. If the sequence lacks expected intermediate frames, the identification component can flag these gaps for further processing by the prediction component. Additionally, it can leverage motion estimation techniques, such as optical flow analysis or deep-learning-based motion tracking, to identify inconsistencies in frame transitions. If motion discontinuities or abrupt visual jumps are detected, the identification component can determine that a missing frame needs to be generated to restore temporal consistency. In some embodiments, the identification component can integrate with an uncertainty estimation model to evaluate the reliability of generated frames. The identification component can analyze the confidence level of each frame prediction and determine whether certain frames require refinement or additional interpolation. For example, if the system generates a frame with a high uncertainty score (e.g., indicating possible inaccuracies in the prediction) the identification component can mark it for further processing, by re-running the prediction component or by enhancing the frame through additional refinement techniques. If the input data contains highly irregular mask distributions (such as cases where large temporal gaps exist between available masks) the identification component can determine whether multiple missing frames need to be generated to reconstruct a smooth motion flow. Conversely, in cases where the mask sequence is only mildly sparse, the component can adjust frame interpolation density accordingly, minimizing redundant computations while ensuring video continuity.

In some embodiments, the artificial intelligence component can train an AI model to enhance the accuracy and efficiency of the video generation process by learning optimal transformations from masks to images and predicting missing frames with high precision. The AI model can be trained using supervised, unsupervised, or reinforcement learning techniques, depending on the availability of labeled data and the specific requirements of the application. For example, in a supervised learning approach, the model can be trained on paired datasets of segmentation masks and corresponding images, allowing it to learn the intricate relationships between anatomical structures and their visual representations. Similarly, for predicting missing frames, the AI model can be trained on sequences of medical images or other domain-specific datasets, learning how to interpolate intermediate frames while preserving structural and contextual consistency. The artificial intelligence component can also implement transfer learning, where a pretrained model is fine-tuned for a specific domain, such as medical imaging or scientific visualization, reducing the need for large-scale data annotation. Additionally, the AI model can continuously improve over time through iterative feedback, where discrepancies in generated videos are analyzed and used to refine model parameters, ensuring progressively higher-quality video synthesis with minimal human intervention.

Various embodiments described herein can be employed to use hardware or software to solve problems that are highly technical in nature (e.g., to facilitate development of continuous videos from sparsely sampled masks), that are not abstract and that cannot be performed as a set of mental acts by a human. Further, some of the processes performed can be performed by a specialized computer (e.g., graphical user interfaces, data encryption, deep learning neural networks) for carrying out defined acts related to video generation. For example, such defined acts can include: accessing, by a device operatively coupled to a processor, a set of masks and a corresponding context; generating, by the device, a sequence of images based on the set of masks and corresponding context; predicting, by the device, what a missing frame in the sequence of images should look like, based on the generated sequence of images; generating, by the device, the missing frame; and integrating, by the device, the generated missing frame into the sequence of images to create a smooth video.

Such defined acts are not performed manually by humans. Indeed, neither the human mind nor a human with pen and paper can efficiently process and generate temporally coherent video sequences from sparse segmentation masks while maintaining spatial and contextual consistency. Indeed, deep learning-based video synthesis, complex frame interpolation, and artificial intelligence models are inherently computerized, hardware-and-software-based constructs that simply cannot be meaningfully implemented or trained in any way by the human mind without computers.

Moreover, various embodiments described herein can integrate into a practical application various teachings relating to video generation. As described above, video generation strategies primarily focus on text-to-video synthesis and next-frame prediction methodologies and do not adequately address the challenge of generating continuous videos from sparse segmentation masks without relying on densely annotated video datasets.

Various embodiments described herein can address one or more of these technical problems. In particular, the present inventors recognized that there is a need for a system that enables the generation of temporally smooth and visually consistent video sequences from limited input data, specifically leveraging segmentation masks and context-driven image generation models to reconstruct missing frames and maintain fluid motion.

Furthermore, various embodiments described herein can control real-world tangible devices based on the disclosed teachings. For example, various embodiments described herein can electronically control specialized computing hardware, such as GPUs, TPUs, and dedicated AI accelerators, to facilitate efficient video generation and processing and can electronically train or execute real-world artificial intelligence models. Specifically, various embodiments described herein can electronically execute mask-to-image transformation models, in-between frame prediction algorithms, and video synthesis pipelines that integrate AI-driven interpolation techniques. These processes can improve the accuracy, efficiency, and scalability of video generation and medical imaging applications, enabling real-time synthesis, adaptive resolution control, and enhanced diagnostic visualization.

Moreover, various embodiments described herein can electronically train and execute artificial intelligence models in real-world environments, enabling automated video synthesis from sparse segmentation masks and real-time refinement of generated frames to enhance temporal and spatial coherence. The artificial intelligence component disclosed herein can learn complex spatial-temporal relationships between frames, optimize video interpolation techniques, and continuously improve generation quality through iterative feedback and model adaptation. In various embodiments, the artificial intelligence component can optimize video generation by leveraging advanced machine learning techniques, such as deep neural networks, generative adversarial networks (GANs), and diffusion models, to synthesize high-quality images and predict missing frames with high accuracy. The AI component can train on large datasets of segmentation masks and corresponding images, learning the intricate relationships between structural outlines and their visual representations. The AI component can refine the generated frames through iterative learning, improving their resolution, texture consistency, and overall realism over multiple training cycles. The AI component can incorporate motion estimation and temporal coherence techniques to ensure that generated frames align smoothly with adjacent images. By analyzing patterns of movement within existing frames, the AI component can predict intermediate frames that maintain natural motion transitions, reducing visual artifacts such as blurring, ghosting, or sudden jumps in motion. The AI component can also integrate domain-specific knowledge, such as anatomical structures in medical imaging, to ensure that synthesized videos remain clinically relevant and diagnostically useful. The AI component can enable real-time processing and adaptive learning to continuously improve video generation outcomes. Through reinforcement learning techniques, the system can adjust its frame prediction and synthesis strategies based on real-time feedback, dynamically optimizing video generation performance. The AI component can also leverage transfer learning, enabling pretrained models to be fine-tuned for specific applications without requiring extensive retraining.

Embodiments described herein can directly control real-world hardware components, such as GPUs, TPUs, and AI accelerators, and specialized medical imaging hardware, to process large-scale video generation tasks efficiently, and enable real-time synthesis of temporally coherent video sequences from sparse segmentation masks. The disclosed system does not merely recite abstract software processes but instead performs concrete computing functions that optimize computational resources for AI-driven video synthesis and enhance the accuracy and applicability of generated video outputs for real-world use cases, such as medical diagnostics, scientific simulations, and industrial monitoring.

It should be appreciated that the figures and description herein provide non-limiting examples of various embodiments and are not necessarily drawn to scale.

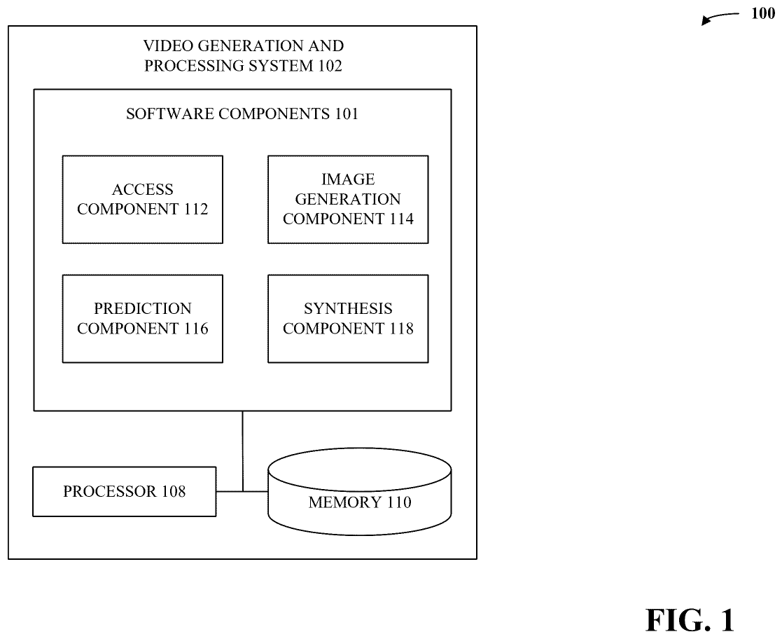

FIG. 1 illustrates a block diagram of an example, non-limiting system 100 that can facilitate efficient video generation and processing. In various embodiments, the video generation and processing system 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components of the vulnerability management system 102 (e.g., access component 112, image generation component 114, prediction component 116, and/or synthesis component 118) to perform one or more acts. In various embodiments, the non-transitory computer-readable memory 110 can store computer-executable components (e.g., access component 112, image generation component 114, prediction component 116, and/or synthesis component 118), and the processor 108 can execute the computer-executable components.

In various embodiments, the video generation and processing system 102 can comprise an access component 112. In various embodiments, the access component 112 can retrieve a set of masks and a corresponding context from a data source, which can include databases, local storage, cloud-based repositories, or real-time input streams. The set of masks accessed by the access component 112 can be a sparse or dense set of segmentation masks, where each mask can represent a structured abstraction of a corresponding image. In the context of medical imaging, segmentation masks can be used to delineate anatomical structures, pathological regions, or other relevant features within an image. Unlike conventional video datasets that require densely annotated frames, the accessed masks can be limited in number and irregularly distributed over time, requiring additional processing to generate a smooth video sequence. The access component 112 can retrieve these masks in various formats, including binary masks, multi-class segmentation maps, or probabilistic masks, depending on the dataset and the intended application. The access component 112 can access a corresponding context, which can provide additional information necessary for image generation. The set of masks and corresponding context can pertain to medical imaging. The context can include metadata associated with masks, such as imaging modality (e.g., MRI, CT, ultrasound), acquisition parameters, or patient-specific information relevant to generation of realistic images. Where the masks represent segmented anatomical structures, lesions, or regions of interest, the corresponding context can provide relevant texture and appearance information derived from medical imaging modalities. The context can encompass reference images, feature embeddings, or prior model-generated outputs that can help guide image generation. In an embodiment utilizing a Context-Semantic Diffusion Model, the context can provide a texture or appearance reference, ensuring that the generated images align with the geometric structure defined by the masks and with expected visual characteristics of the target domain. The access component 112 can implement various preprocessing techniques to optimize the retrieved masks and context before passing them to subsequent components. The access component 112 can normalize mask dimensions, standardize intensity values, or apply geometric transformations to ensure consistency across a dataset. Where masks are derived from heterogeneous sources, the access component 112 can resolve inconsistencies by harmonizing mask formats, interpolating missing data, or performing spatial alignment to enhance compatibility.

In various embodiments, the video generation and processing system 102 can comprise an image generation component 114. The image generation component 114 can generate a sequence of images based on the set of masks and corresponding context. The sequence of images generated by the image generation component 114 can align with the geometric structure defined by the masks while adhering to the visual characteristics provided by the context. The image generation component 114 can be designed to process both sparse and dense sets of masks, ensuring that each generated image maintains consistency in spatial structure and appearance. When the access component retrieves a sparse set of masks, the image generation component 114 can generate images corresponding to the available masks while preserving contextual and textural continuity across frames. The image generation component 114 can employ a diffusion-based technique to iteratively refine the generated images, ensuring that each image adheres to the geometry of the input masks while maintaining visually realistic textures from the corresponding context. This iterative refinement can involve progressive noise removal and feature enhancement, allowing the model to generate high-fidelity images that accurately reflect the underlying structures represented by the masks. Additionally, the image generation component 114 can utilize a pretrained mask-to-image model, such as the Context-Semantic Diffusion Model, which can incorporate learned representations of domain-specific textures and structures to improve the realism of the generated images. The image generation component 114 can also incorporate adaptive techniques to balance geometric fidelity with texture realism. For example, the image generation component 114 can apply context-aware weighting mechanisms to ensure that fine-grained details from the context are preserved while strictly adhering to the mask constraints. Furthermore, the image generation component 114 can support multi-resolution processing, allowing images to be generated at different scales to accommodate various downstream applications.

In various embodiments, the video generation and processing system 102 can comprise a prediction component 116. The prediction component 116 can predict what a missing frame should look like based on the generated sequence of images. The prediction component 116 can analyze the spatial and temporal relationships between existing frames to generate intermediate frames that ensure smooth visual transitions. When the access component retrieves a sparse set of masks and the image generation component generates images for the available masks, the prediction component 116 can generate the missing frames to maintain temporal consistency across the video sequence. This predictive capability can be particularly beneficial in scenarios where the original input data lacks a complete sequence of frames, as it allows for the reconstruction of a continuous video from limited initial inputs. The prediction component 116 can generate missing frames using a frame generation process based on in-between frame prediction. This approach can estimate and synthesize the appearance of intermediate frames by analyzing the structure and content of adjacent frames. Given two reference frames xᵢ and xⱼ, the missing frame \hat{x}ₜ can be predicted (e.g., by the prediction component 116) using the function f(xᵢ, xⱼ)=\hat{x}ₜ, where t∈(i, j). This function can incorporate motion estimation techniques, optical flow analysis, or deep-learning-based interpolation methods to predict intermediate frames with high accuracy. By leveraging these techniques, the prediction component 116 can generate temporally consistent frames that align seamlessly with the surrounding images, ensuring that the resulting video maintains both structural integrity and smooth transitions. Generating the missing frames using the frame generation process can enable smooth interpolation without requiring training on data from a specific target modality. Unlike conventional next-frame prediction models that rely on dense training datasets from a specific domain, the in-between frame prediction process can operate across various modalities and applications. The prediction component 116 can adaptively estimate motion and texture details based on the available frames, making it highly flexible for different types of video generation tasks, including medical imaging, scientific visualization, and general-purpose video synthesis.

In various embodiments, the video generation and processing system 102 can comprise a synthesis component 118. The synthesis component 118 can integrate the generated missing frame into the sequence of images to create a smooth video. The synthesis component 118 can take the predicted intermediate frames produced by the prediction component and seamlessly position them between the corresponding reference frames to ensure that transitions appear natural and fluid. By aligning the missing frames with the surrounding images, the synthesis component 118 can mitigate visual artifacts, abrupt transitions, or inconsistencies that may arise when interpolating between sparsely sampled input data. This integration process can enhance the realism of the generated video, making it suitable for applications that require high temporal and spatial fidelity. The synthesis component 118 can employ various techniques to refine the integration process, including blending algorithms, temporal filtering, and motion smoothing. These techniques can help minimize discrepancies between adjacent frames, ensuring that the transitions between generated and original frames are indistinguishable. Additionally, the synthesis component 118 can perform adaptive adjustments to harmonize brightness, contrast, and texture details across frames, preventing visible discontinuities. In some implementations, it can leverage deep-learning-based refinement models to further enhance frame alignment and smoothness, optimizing the overall perceptual quality of the generated video. By integrating missing frames in a structured manner, the synthesis component 118 can construct a continuous video sequence even when the input data consists of only a sparse set of segmentation masks. This capability can be particularly beneficial in domains such as medical imaging, where obtaining fully annotated video data is challenging. The synthesis component 118 can ensure that the final video output accurately represents the intended motion and structure, preserving both the geometric constraints of the input masks and the contextual details provided by the image generation component.

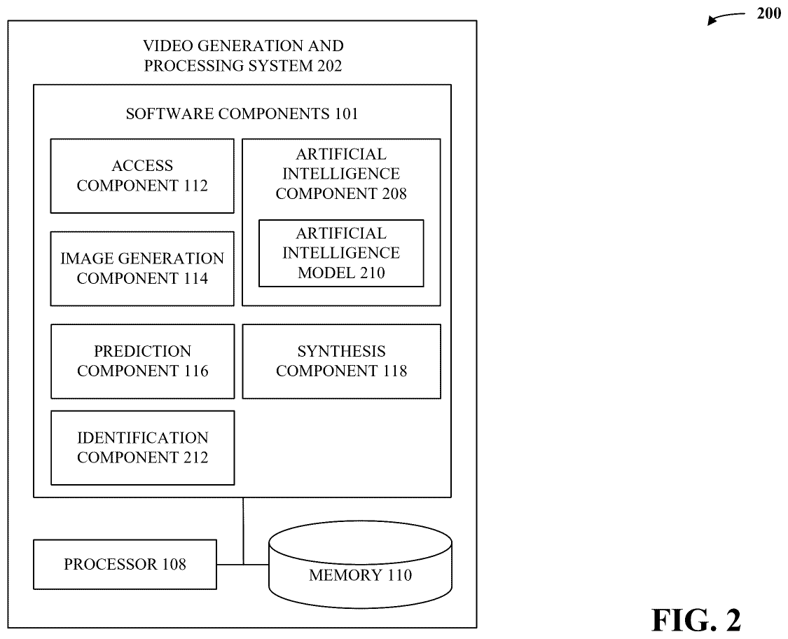

FIG. 2 illustrates a block diagram of an example, non-limiting system 200 that facilitates efficient video generation and processing. As shown, the system 200 can, in some cases, comprise the same components as the system 100, and can further comprise an artificial intelligence component 208 and an identification component 212.

The artificial intelligence component 208 can train an AI model to enhance the accuracy and efficiency of the video generation process by learning optimal transformations from masks to images and predicting missing frames with high precision. The AI model can be trained using supervised, unsupervised, or reinforcement learning techniques, depending on the availability of labeled data and the specific requirements of the application. For example, in a supervised learning approach, the model can be trained on paired datasets of segmentation masks and corresponding images, allowing it to learn the intricate relationships between anatomical structures and their visual representations. Similarly, for predicting missing frames, the AI model can be trained on sequences of medical images or other domain-specific datasets, learning how to interpolate intermediate frames while preserving structural and contextual consistency. The artificial intelligence component 208 can also implement transfer learning, where a pretrained model is fine-tuned for a specific domain, such as medical imaging or scientific visualization, reducing the need for large-scale data annotation. Additionally, the AI model can continuously improve over time through iterative feedback, where discrepancies in generated videos are analyzed and used to refine model parameters, ensuring progressively higher-quality video synthesis with minimal human intervention.

In various aspects, the identification component 212 can examine the generated sequence of images and identify a missing frame within the sequence of images. The identification component 212 can analyze the temporal consistency and spatial alignment of the generated frames to detect gaps, irregular transitions, or missing data points within the sequence. The identification component 212 can operate by scanning the input sequence and applying various image-processing and machine-learning techniques to determine whether any frames are absent or if additional interpolated frames are required to maintain a smooth and coherent video. The identification component 212 can employ multiple detection strategies to assess the completeness of the generated video sequence. In one embodiment, it can utilize a frame-indexing approach, where it sequentially checks for expected frame positions based on the initial mask input distribution. If the sequence lacks expected intermediate frames, the identification component 212 can flag these gaps for further processing by the prediction component. Additionally, it can leverage motion estimation techniques, such as optical flow analysis or deep-learning-based motion tracking, to identify inconsistencies in frame transitions. If motion discontinuities or abrupt visual jumps are detected, the identification component 212 can determine that a missing frame needs to be generated to restore temporal consistency. In some embodiments, the identification component 212 can integrate with an uncertainty estimation model to evaluate the reliability of generated frames. The identification component 212 can analyze the confidence level of each frame prediction and determine whether certain frames require refinement or additional interpolation. For example, if the system generates a frame with a high uncertainty score (e.g., indicating possible inaccuracies in the prediction) the identification component 212 can mark it for further processing, by re-running the prediction component or by enhancing the frame through additional refinement techniques. If the input data contains highly irregular mask distributions (such as cases where large temporal gaps exist between available masks) the identification component 212 can determine whether multiple missing frames need to be generated to reconstruct a smooth motion flow. Conversely, in cases where the mask sequence is only mildly sparse, the component can adjust frame interpolation density accordingly, minimizing redundant computations while ensuring video continuity.

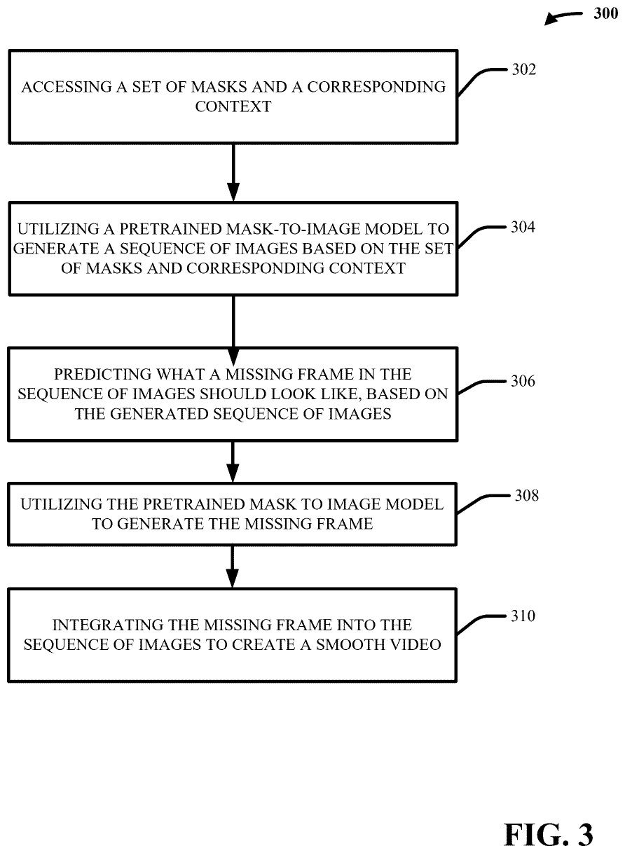

FIG. 3 illustrates a flow diagram of an example, non-limiting computer-implemented method 300 that can facilitate efficient video generation and processing in accordance with one or more embodiments described herein.

In various embodiments, act 302 can include accessing, by a device (e.g., via 112) operatively coupled to a processor (e.g., 108), a set of masks and a corresponding context. The device can retrieve the masks and context from various data sources, such as local storage, cloud-based repositories, or real-time input streams. The set of masks can be a sparse or dense collection of segmentation masks, where each mask represents a structured outline corresponding to specific regions or features within an image. The corresponding context can include additional metadata, such as imaging modality, acquisition parameters, or reference textures that help guide the image generation process. The process of accessing masks and context can include several preparatory steps to ensure compatibility with downstream components. For instance, the device can perform data normalization, format conversion, and spatial alignment to standardize the retrieved inputs. In some implementations, the device can integrate preprocessing techniques such as noise reduction or geometric transformations to enhance the quality of the input data. The device (e.g., via access component 112) can also dynamically determine whether additional contextual information is needed to improve generation accuracy, retrieving supplementary data from related sources if required. Furthermore, the device can leverage intelligent data management techniques to optimize the efficiency of accessing masks and context. For example, caching mechanisms can be used to store frequently accessed masks, reducing retrieval latency and computational overhead. Additionally, in distributed processing environments, the device can prioritize the retrieval of masks based on their relevance to the target video sequence, ensuring that critical frames are processed first.

In various embodiments, act 304 can include generating, by a device (e.g., via 114) operatively coupled to a processor (e.g., 108), a sequence of images based on the set of masks and corresponding context. Act 304 can include utilizing a pretrained mask-to-image model to generate the sequence of images. This process can involve transforming structural outlines provided by the masks into fully realized images that match the geometric constraints of the masks while maintaining the texture, shading, and visual details derived from the context. The image generation process can leverage advanced generative models, such as diffusion-based models or deep-learning-driven mask-to-image transformations, to synthesize high-fidelity images that accurately reflect the intended subject matter. Ensuring that the generated images align with both the masks and the contextual information can preserve structural integrity while enhancing realism. To achieve high-quality image synthesis, a multi-stage generative pipeline can be employed that can progressively refine the output images. Initially, coarse representations of the images can be produced based on the masks, ensuring that the structural elements remain intact. In subsequent refinement stages, additional layers of detail, such as texture, illumination, and domain-specific visual features, can be incorporated based on the contextual data. This iterative refinement can enable the generation of images that adhere to mask constraints and exhibit high levels of visual realism, thereby reducing the likelihood of inconsistencies or artifacts. Additionally, the image generation process can be optimized for computational efficiency using adaptive techniques such as resolution scaling, conditional generation, and selective model pruning. For instance, in scenarios where only a low-resolution output is required, the generative model parameters can be adjusted to prioritize faster inference times while maintaining acceptable image quality. Conversely, for applications that require high-detail synthesis, such as medical diagnostics, higher-resolution generation techniques can be employed to ensure maximum accuracy.

In various embodiments, act 306 can include predicting, by a device (e.g., via 116) operatively coupled to a processor (e.g., 108), what a missing frame in the sequence of images should look like, based on the generated sequence of images. This prediction process can ensure temporal continuity and smooth motion transitions by estimating intermediate frames that are not explicitly provided by the input masks. The spatial and temporal relationships between adjacent frames can be analyzed to generate an accurate representation of the missing frame, preserving both the structural integrity of the scene and the visual coherence required for a seamless video sequence. By leveraging advanced interpolation techniques, such as deep-learning-based in-between frame generation, motion estimation, and optical flow analysis, the device can accurately reconstruct frames that align naturally with surrounding images. The prediction process can be performed using a frame generation model designed to interpolate frames between two or more reference images. Given two reference frames, xᵢ and xⱼ, the missing frame \hat{x}ₜ can be predicted using the function f(xᵢ, xⱼ)=\hat{x}ₜ, where t∈(i, j). This function can incorporate learned representations of motion dynamics, texture synthesis, and structural continuity to generate realistic intermediate frames. Unlike conventional next-frame prediction methods, which rely on dense sequential data, the proposed method can operate effectively with sparse input frames, making it particularly advantageous in scenarios where only a limited number of keyframes are available, such as medical imaging, animation, or scientific simulations. Additionally, adaptive techniques can be employed to enhance prediction accuracy based on the complexity of motion in the sequence. For example, if the motion between two reference frames is minimal, simple interpolation techniques can be applied to estimate the missing frame efficiently. However, in cases where significant motion occurs between frames, more sophisticated motion-aware generation models that incorporate learned temporal dynamics can be utilized to produce highly realistic intermediate frames.

In various embodiments, act 308 can include generating, by a device (e.g., via 116) operatively coupled to a processor (e.g., 108), the missing frame. In some embodiments, act 308 can include utilizing a pretrained mask-to-image model to generate the missing frame. This process can leverage advanced deep-learning models to synthesize a high-fidelity frame that can seamlessly align with both the spatial and temporal characteristics of adjacent frames. Given the sparse nature of the input masks, generating a missing frame can require not only interpolating between existing images but also ensuring that the newly generated frame remains structurally and contextually consistent. The process can involve analyzing motion trajectories, texture patterns, and geometric transformations present in the reference frames to create a visually coherent output. To ensure accuracy, the missing frame can be generated using a combination of frame prediction models and learned motion estimation techniques. One approach can involve applying a diffusion-based generative model, which can iteratively refine the generated frame by adding realistic details while preserving structural constraints. Another approach can incorporate optical flow estimation, where pixel movement between adjacent frames can be analyzed to generate a frame that accurately represents the intermediate state of motion. These techniques can be combined with spatial-awareness algorithms that can ensure the generated frame aligns precisely with the contours and texture details derived from the surrounding images. Moreover, the system can dynamically adjust the generation strategy based on the complexity of the motion between existing frames. For simple cases with minimal motion, direct interpolation techniques can be applied to generate a smooth transition between images. However, for more complex cases involving significant transformations, occlusions, or deformations, the system can employ more sophisticated generative models that can adaptively infer missing details.

In various embodiments, act 310 can include integrating, by a device (e.g., via 118) operatively coupled to a processor (e.g., 108), the generated missing frame into the sequence of images to create a smooth video. The generated frame can be aligned with adjacent frames to ensure seamless transitions while preserving spatial and motion continuity. Various post-processing techniques, such as adaptive blending and motion-aware smoothing, can be applied to refine the transition between frames and prevent abrupt changes in texture, color, or structure. Frame properties can be adjusted to match the visual characteristics of the surrounding images. brightness normalization, contrast adjustment, and texture harmonization techniques can be applied to ensure that the newly integrated frame does not introduce visible artifacts. Additionally, temporal filtering algorithms can be used to minimize flickering effects and ensure smooth transitions between frames, particularly in cases where rapid movement or varying lighting conditions are present. These refinements can help maintain the perceptual realism of the generated video, ensuring that the interpolated frames blend naturally with the original data. In some embodiments, real-time quality assessment mechanisms can be employed to validate the integration of the missing frame.

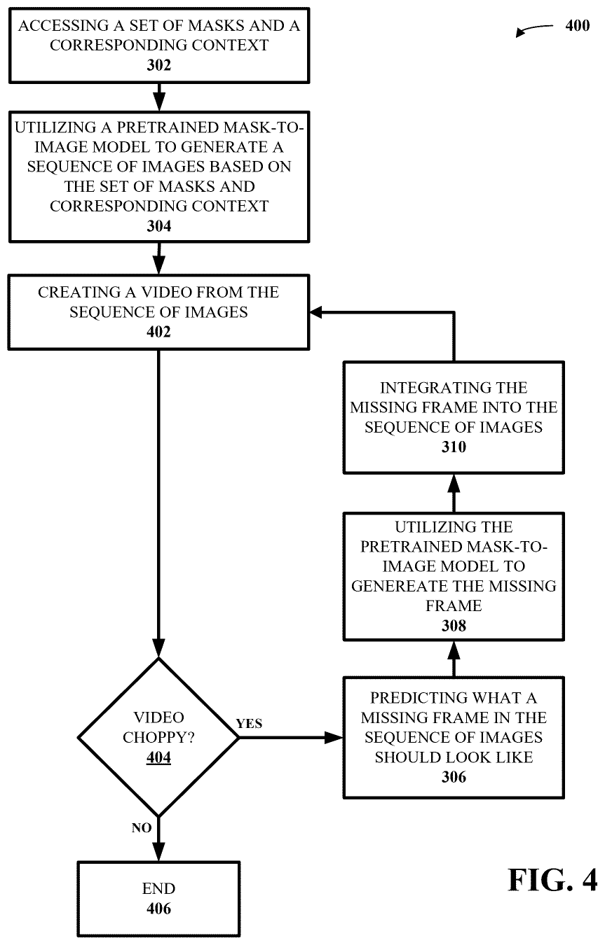

FIG. 4 illustrates a flow diagram of an example, non-limiting computer-implemented method 400 that can facilitate efficient video generation and processing in accordance with one or more embodiments described herein. Repeated descriptions of like elements have been omitted for brevity.

In various embodiments, act 402 can include creating, by a device (e.g., via 116) operatively coupled to a processor (e.g., 108), a video from a sequence of images. This process can involve assembling the generated images, including any missing frames that have been synthesized, into a temporally coherent video format. The creation of the video can include encoding the frames in a structured sequence with a defined frame rate, ensuring that the motion between frames appears fluid and natural. Various encoding techniques, such as interpolation-based smoothing or motion-aware frame arrangement, can be applied to enhance visual consistency. The system can also support different frame rates, resolutions, and compression formats depending on the target application, allowing for flexible integration into diverse use cases such as medical imaging, scientific visualization, and multimedia content generation. To optimize video quality, additional processing techniques can be applied during video creation. These can include adaptive frame rate adjustments, where the system dynamically determines the optimal number of frames per second (fps) based on motion complexity within the sequence. For instance, if motion is minimal, the system can reduce the frame rate to conserve computational resources while maintaining visual smoothness. Conversely, for sequences with significant movement, a higher frame rate can be used to preserve detail and ensure a more natural flow. The system can also employ post-processing enhancements such as motion stabilization, contrast adjustments, and color correction to further refine the visual output.

In various embodiments, act 404 can include determining, by a device (e.g., via 116) operatively coupled to a processor (e.g., 118 or 208), whether the video is smooth. This process can involve analyzing the temporal coherence of the frames and assessing whether any inconsistencies, such as abrupt transitions, flickering, or unnatural motion artifacts, are present. The system can employ various evaluation metrics, such as optical flow analysis, structural similarity index (SSIM), or deep-learning-based perceptual quality assessments, to quantify the smoothness of the video. If the analysis determines that the video maintains a natural motion flow, the method can conclude, indicating that the generated output meets the required quality standards.

If the video is determined to be choppy, the method can proceed to act 306, where additional missing frames can be generated to improve continuity. This iterative refinement process can allow the system to adaptively enhance the video until an optimal smoothness level is achieved. Once new frames have been generated and integrated into the sequence, the method can return to act 404 to re-evaluate the updated video. This feedback loop ensures that the final video output is visually consistent and free of artifacts before it is finalized. Through this iterative approach, the system can dynamically adjust and refine the video, improving its quality and ensuring that it meets the intended application's requirements.

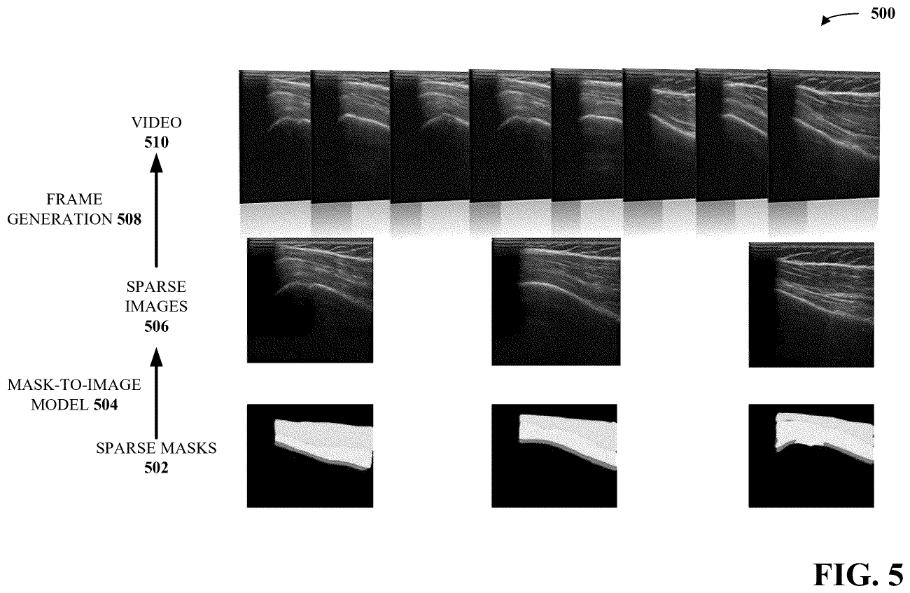

Next, FIG. 5 illustrates an example, non-limiting system architecture 500 that can facilitate efficient video generation and processing in accordance with one or more embodiments described herein.

System architecture 500 can include sparse masks 502. In various embodiments, sparse masks 502 can serve as the foundational input for the video generation process, providing structural guidance for image synthesis. Sparse masks can be segmentation masks that define specific regions of interest within an image but are not densely annotated across all frames of a video sequence. These masks can be extracted from various sources, such as medical imaging scans, scientific visualizations, or computer vision applications, where full-frame annotations are impractical or unavailable. Unlike conventional video datasets that include frame-by-frame annotations, sparse masks 502 can represent key points or partial structures, requiring additional processing to interpolate and generate a complete, temporally coherent video. Sparse masks 502 can be utilized to guide the mask-to-image transformation process, ensuring that the generated images align with predefined structures while preserving essential visual characteristics. Given that the masks may be limited in number and irregularly distributed in time, the system can intelligently interpolate missing frames using predictive algorithms to maintain continuity. The sparsity of these masks can pose challenges in terms of motion estimation and frame synthesis; however, by leveraging deep-learning-based generation techniques, the system can infer missing details and create smooth transitions between sparse input frames. Furthermore, sparse masks 502 can be dynamically processed and enhanced to optimize their utility in the video generation pipeline. Preprocessing techniques such as spatial alignment, normalization, and noise reduction can be applied to refine the input masks before they are fed into the image generation model. In some embodiments, adaptive weighting mechanisms can be employed to prioritize certain masks based on their relevance, ensuring that the most critical frames are accurately represented in the final video output.

System architecture 500 can include mask-to-image model 504. In various embodiments, mask-to-image model 504 can transform sparse masks 502 into high-fidelity images that serve as the foundation for video generation. The mask-to-image model 504 can leverage deep-learning-based generative techniques to synthesize images that align with the geometric structures defined by the masks 502 while preserving the visual realism necessary for the given application. The model 504 can be designed to operate across various input types, including binary segmentation masks, multi-class masks, or probabilistic masks, making it adaptable to different fields such as medical imaging, scientific simulations, and computer vision tasks. Mask-to-image model 504 can employ diffusion-based or adversarial generative approaches to refine the transformation process. For example, a diffusion model can iteratively denoise and enhance the generated images, ensuring that they retain both structural integrity and natural appearance. Alternatively, a generative adversarial network (GAN)-based approach can use a discriminator to assess image quality, allowing the model to improve its output through adversarial training. In some implementations, a Context-Semantic Diffusion Model can be used, where the generated image is conditioned not only on the input mask but also on contextual information such as reference textures or domain-specific metadata. Additionally, mask-to-image model 504 can support multi-resolution synthesis, allowing images to be generated at different levels of detail depending on the requirements of the final video. In cases where a lower-resolution output is sufficient, the model 504 can adjust its computational workload accordingly, optimizing processing speed while maintaining acceptable image quality. Conversely, for high-precision applications such as medical imaging, the model 504 can generate high-resolution images with fine-grained anatomical details.

System architecture 500 can include sparse images 506. In various embodiments, sparse images 506 can represent the initial set of generated images derived from sparse masks 502 using mask-to-image model 504. These images can serve as key reference points within the video sequence but may be distributed non-uniformly across the timeline, requiring additional processing to interpolate missing frames and ensure smooth temporal transitions. Sparse images 506 can capture essential structural and contextual details from the input masks, preserving the geometric relationships while incorporating domain-specific textures and visual features necessary for high-quality video generation. The sparsity of these images can vary depending on the input data. Sparse images 506 can undergo preprocessing and enhancement to optimize their usability in the video generation pipeline. Techniques such as image sharpening, contrast adjustment, and noise reduction can be applied to ensure that the generated frames are visually consistent and free of distortions. In some embodiments, these sparse images can also be used as anchors for adaptive frame interpolation.

System architecture 500 can include frame-generation model 508. In various embodiments, frame-generation model 508 can be responsible for predicting and generating missing frames between sparse images 506 to create a smooth and temporally coherent video. Since sparse images 506 may be irregularly distributed in time, the frame-generation model 508 can analyze the available frames and synthesize intermediate frames that maintain structural consistency and natural motion transitions. Frame-generation model can utilize advanced deep-learning-based interpolation techniques, motion estimation models, and generative adversarial networks (GANs) to ensure that the predicted frames accurately reflect the underlying movement and texture patterns. Frame-generation model 508 can employ in-between frame prediction, where two or more reference images are taken and an intermediate frame is estimated based on the spatial and temporal relationships between the two or more reference images. Given two reference frames xᵢ and xⱼ, frame-generation model 508 can predict the missing frame \hat{x}ₜ using the function f(xᵢ, xⱼ)=\hat{x}ₜ, where t∈(i, j). To further enhance video smoothness, frame-generation model 508 can incorporate adaptive techniques that adjust frame synthesis based on motion complexity. For simple, slow-moving sequences, the model 508 can use basic interpolation techniques to estimate missing frames efficiently. However, for sequences with complex motion, occlusions, or non-linear transformations, more advanced models can be applied to reconstruct frames with high accuracy. The model 508 can also leverage multi-scale processing, generating low-resolution frames first to establish motion flow before refining details at higher resolutions.

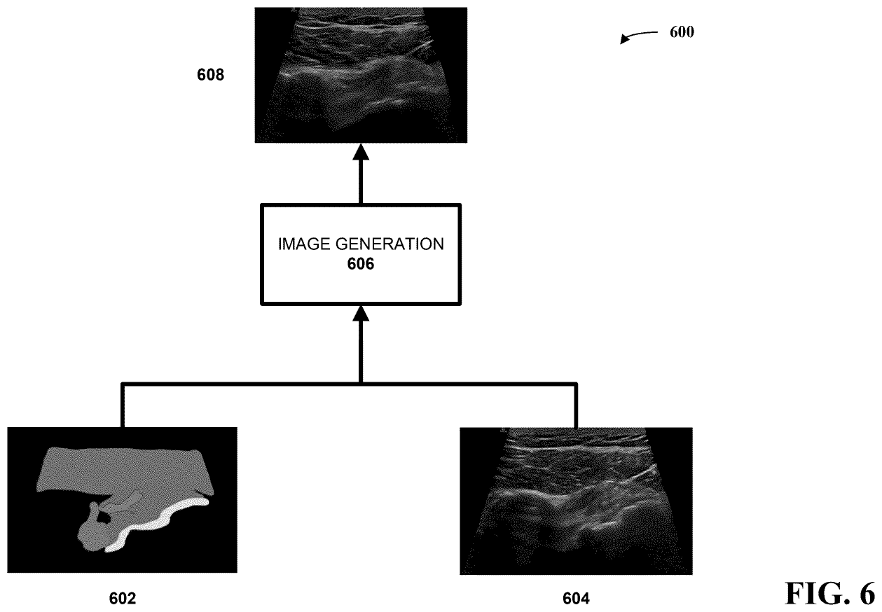

FIG. 6 illustrates an example, non-limiting system architecture 600 of a mask-to image-model in accordance with one or more embodiments described herein. This architecture can be responsible for transforming input mask images into fully realized images by leveraging contextual information and an advanced image generation model. The components of system architecture 600 can work together to ensure that the generated images maintain structural integrity while incorporating realistic textures, shading, and other relevant details.

In some examples, a mask image, such as mask image 602, can serve as the foundational structural input for the mask-to-image transformation process. A mask image can be a segmentation map that outlines key features, regions, or objects within an image. These masks can be binary (highlighting a single region of interest) or multi-class (defining multiple segmented regions), depending on the application. In fields such as medical imaging, mask images can represent anatomical structures, tumors, or lesions that need to be reconstructed into realistic images.

In various examples, a context image, such as context image 604, can provide additional visual guidance to enhance the image generation process. A context image can include reference textures, style information, or domain-specific visual features that ensure the generated image aligns with expected real-world appearances.

In some examples, an image generation model, such as image generation model 606, can convert the mask image 602 into a high-fidelity image using the context image 604 as a reference. The image generation model 606 can employ deep-learning techniques, such as diffusion-based generative models, generative adversarial networks (GANs), or transformer-based architectures, to synthesize images that maintain both geometric accuracy and photorealistic textures. The model 606 can iteratively refine the generated images, progressively adding details and adjusting textures to match the characteristics of the provided context image.

In various examples, a generated image, such as generated image 608, can represent a fully reconstructed version of the mask image 602, enriched with textures, shading, and other visual details derived from the context image 604.

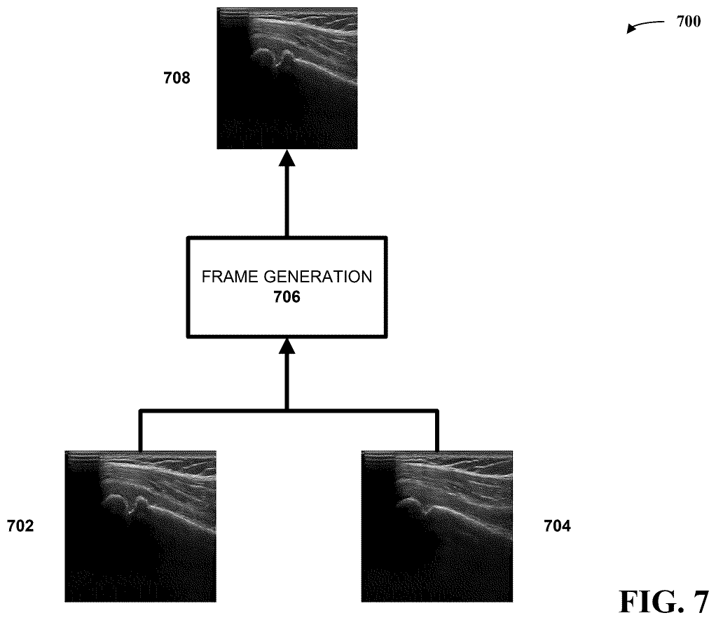

FIG. 7 illustrates an example, non-limiting system architecture 700 of a frame generation model that can facilitate efficient video generation and processing in accordance with one or more embodiments described herein. System architecture 700 can enable synthesis of missing frames between temporally sparse images, ensuring smooth and natural motion in a generated video. By leveraging deep-learning-based interpolation and motion estimation techniques, system architecture 700 can generate high-fidelity intermediate frames that can maintain spatial consistency and preserve natural motion transitions.

In some examples, two images from different time stamps 702 and 704 can be generated from a mask-to-image model, extracted from an existing dataset, or derived from real-world visual inputs. Since these images are sampled at discrete time points, there can be missing frames between them that need to be synthesized to create a smooth video. The temporal gap between 702 and 704 can vary depending on the application; for instance, in medical imaging, these images can represent different stages of an anatomical process, while in other video generation tasks, they can depict motion between two points in time.

In various examples, frame generation process 706 can involve advanced interpolation techniques, such as optical flow analysis, deep-learning-based in-between frame prediction, or motion-aware generative modeling. Given two reference frames xᵢ and xⱼ, (e.g., 702 and 704), the missing frame \hat{x}ₜ (e.g., 708) can be estimated using a function such as f(xᵢ, xⱼ)=\hat{x}ₜ, where t∈(i, j). To improve the realism and accuracy of generated frames, the frame generation process can incorporate multi-scale processing, where coarse motion estimation is performed first, followed by high-resolution refinement. Additionally, deep-learning models trained on large-scale datasets can be used to recognize common motion trajectories and apply learned transformations to the generated frames. In some embodiments, temporal coherence mechanisms can be employed to ensure that generated frames align seamlessly with both preceding and following frames, reducing artifacts such as blurring or unnatural distortions.

In some examples, the generated frame 708 can be seamlessly integrated into the video sequence to enhance motion fluidity and maintain structural consistency. The generated frame 708 can undergo post-processing to further refine its quality, including techniques such as noise reduction, contrast adjustment, and motion-aware smoothing.

By leveraging system architecture 700, the frame generation model can effectively reconstruct missing frames, enabling the synthesis of high-quality video sequences from sparse image inputs.

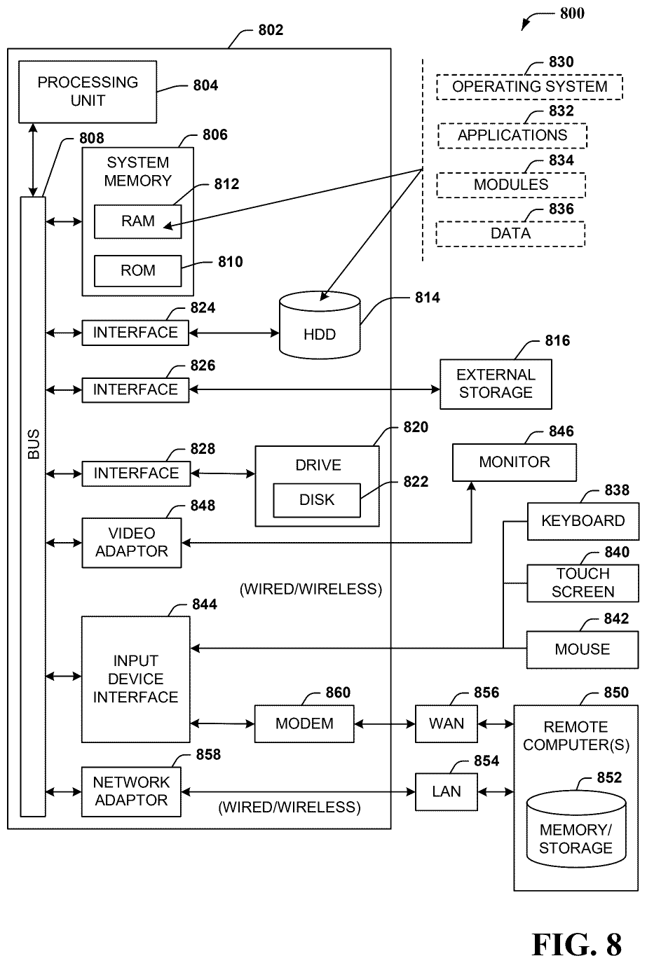

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and a drive 820, e.g., such as a solid state drive, an optical disk drive, which can read or write from a disk 822, such as a CD-ROM disc, a DVD, a BD, etc. Alternatively, where a solid state drive is involved, disk 822 would not be included, unless separate. While the internal HDD 814 is illustrated as located within the computer 802, the internal HDD 814 can also be configured for external use in a suitable chassis (not shown). Additionally, while not shown in environment 800, a solid state drive (SSD) could be used in addition to, or in place of, an HDD 814. The HDD 814, external storage device(s) 816 and drive 820 can be connected to the system bus 808 by an HDD interface 824, an external storage interface 826 and a drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can be enabled with a security module, such as a trusted processing module (TPM). For instance, with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 846 or other type of display device can also be connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above, such as but not limited to a network virtual machine providing one or more aspects of storage or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

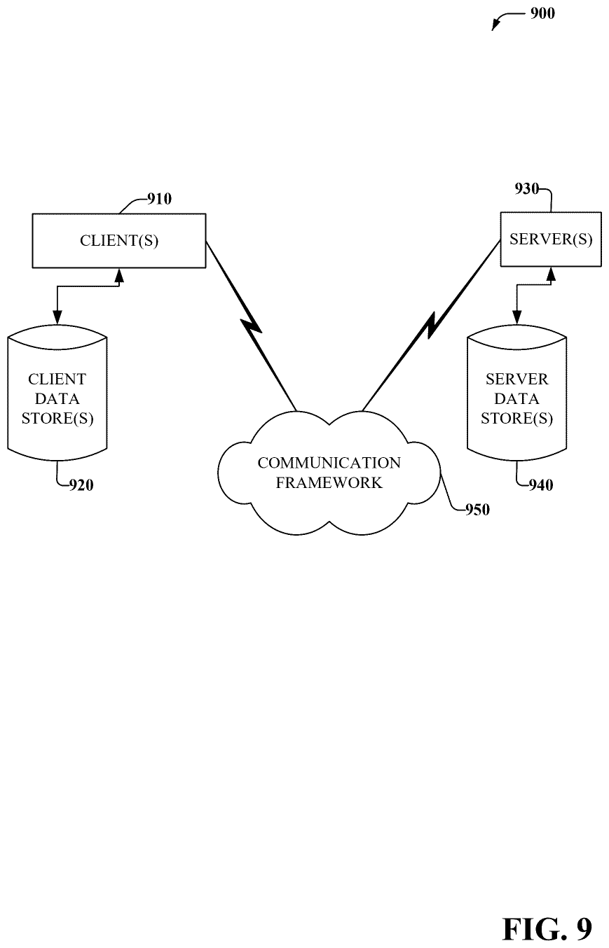

FIG. 9 is a schematic block diagram of a sample computing environment 900 with which the disclosed subject matter can interact. The sample computing environment 900 includes one or more client(s) 910. The client(s) 910 can be hardware or software (e.g., threads, processes, computing devices). The sample computing environment 900 also includes one or more server(s) 930. The server(s) 930 can also be hardware or software (e.g., threads, processes, computing devices). The servers 930 can house threads to perform transformations by employing one or more embodiments as described herein, for example. One possible communication between a client 910 and a server 930 can be in the form of a data packet adapted to be transmitted between two or more computer processes. The sample computing environment 900 includes a communication framework 950 that can be employed to facilitate communications between the client(s) 910 and the server(s) 930. The client(s) 910 are operably connected to one or more client data store(s) 920 that can be employed to store information local to the client(s) 910. Similarly, the server(s) 930 are operably connected to one or more server data store(s) 940 that can be employed to store information local to the servers 930.

Various embodiments can be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The disclosure herein describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
an access component that accesses a set of masks and a corresponding context;
an image generation component that utilizes a pretrained mask-to-image model to generate a sequence of images based on the set of masks and corresponding context;
a prediction component that predicts what a missing frame should look like, based on the generated sequence of images, and utilizes the pretrained mask-to-image model to generate the missing frame; and
a synthesis component that integrates the generated missing frame into the sequence of images to create a smooth video.

2. The system of claim 1, wherein the sequence of images generated by the image generation component matches one of the mask from the set of masks in geometry and matches the corresponding context in appearance.

3. The system of claim 2, wherein the access component retrieves a sparse set of masks, the image generation component generates images for available masks, and the prediction component generates missing frames to maintain temporal consistency.

4. The system of claim 2, wherein the image generation component employs a diffusion-based technique to iteratively refine the sequence of images such that the sequence of images adheres to the geometry of the masks while maintaining visually realistic textures from the corresponding context.

5. The system of claim 1, wherein the prediction component generates the missing frame using a frame generation process based on in-between frame prediction.

6. The system of claim 5, wherein, given two reference frames xᵢ and xⱼ, the missing frame \hat{x}ₜ is predicted using a function f(xᵢ, xⱼ)=xₜ, where t∈(i, j).

7. The system of claim 6, wherein generating the missing frame using the frame generation process enables smooth interpolation without requiring training on data from a specific target modality.

8. The system of claim 1, wherein the set of masks and corresponding context pertain to medical imaging.

9. The system of claim 8, wherein the masks represent segmented anatomical structures, lesions, or regions of interest, and the corresponding context provides relevant texture and appearance information derived from medical imaging modalities.

10. A computer-implemented method, comprising:
accessing, by a device operatively coupled to a processor, a set of masks and a corresponding context;
utilizing, by the device, a pretrained mask-to-image model to generate a sequence of images based on the set of masks and corresponding context;
predicting, by the device, what a missing frame in the sequence of images should look like, based on the generated sequence of images;
utilizing, by the device, the pretrained mask-to-image model to generate the missing frame; and
integrating, by the device, the generated missing frame into the sequence of images to create a smooth video.

11. The computer-implemented method of claim 10, wherein the sequence of images matches the mask in geometry and matches the context in appearance.

12. The computer-implemented method of claim 11, further comprising:
retrieving, by the device, a sparse set of masks;
utilizing, by the device, the pretrained mask-to-image model to generate images for the available masks; and
utilizing, by the device, the pretrained mask-to-image model to generate missing frames to maintain temporal consistency.

13. The computer-implemented method of claim 11, further comprising deploying, by the device, a diffusion-based technique to iteratively refine the generated images such that the generated images adhere to the geometry of the masks while maintaining visually realistic textures from the corresponding context.

14. The computer-implemented method of claim 10, wherein the pretrained mask-to-image model to generates the missing frames using a frame generation process based on in-between frame prediction.

15. The computer-implemented method of claim 14, wherein, given two reference frames xᵢ and xⱼ, the missing frame \hat{x}ₜ is predicted using the function f(xᵢ, xⱼ)=\hat{x}ₜ, where t∈(i, j).

16. The computer-implemented method of claim 14, wherein generating the missing frames using the frame generation process enables smooth interpolation without requiring training on data from a specific target modality.

17. The computer-implemented method of claim 10, wherein the set of masks and corresponding context pertain to medical imaging.

18. Computer-implemented method of claim 17, wherein the masks represent segmented anatomical structures, lesions, or regions of interest, and the corresponding context provides relevant texture and appearance information derived from medical imaging modalities.

19. A computer program product for facilitating temporal consistency in a video, the computer program product comprising a non-transitory computer-readable memory having program instructions embodied therewith, the program instructions executable by a processor to cause the processor to:
access a set of masks and a corresponding context;
utilize a pretrained mask-to-image model to generate a sequence of images based on the set of masks and corresponding context;
predict what a missing frame in the sequence of images should look like, based on the generated sequence of images;
utilize the pretrained mask-to-image model to generate the missing frame; and
integrate the generated missing frame into the sequence of images to create a smooth video.

20. The computer program product of claim 19, wherein the sequence of images matches the mask in geometry and matches the context in appearance.
